(19) United States
(12) Patent Application Publication
(10) Pub. No.: US 2020/0329653 A1
(43) Pub. Date: Oct. 22, 2020

(54) Electrostatic Aeroponics

(71) Applicant: Hall Labs, LLC, Provo, UT (US)

(72) Inventors: David R. Hall, Provo, UT (US); Dustin Clouse, Springville, UT (US)

(73) Assignee: Hall Labs, LLC, Provo, UT (US)

(21) Appl. No.: 16/388,864

(22) Filed: Apr. 18, 2019

(51) Int. Cl. A01G 31/02; A01G 7/04

(52) U.S. Cl. CPC A01G 31/02; A01G 9/047; A01G 7/04

(57) ABSTRACT

An apparatus and corresponding method are disclosed. The apparatus comprises an aeroponic growing container and a fog transportation system that moves nutrient-rich fog into the aeroponic growing container. The container may comprise one or more electrically grounded plants or one or more electrically grounded plant support structures that suspend one or more plants. The fog transportation system comprises an electrode that transfers an electrical charge to the nutrient-rich fog, such that the nutrient-rich fog is electrically attracted to the one or more plants. The method comprises providing an aeroponic growing container comprising one or more plant support structures that suspend one or more plants, electrically grounding the plant support structures, and transporting nutrient-rich fog into the container by means of a fog transportation system. The fog transportation system comprises an electrode that transfers an electrical charge to the fog, such that the fog is electrically attracted to the plants.

### TECHNICAL FIELD

This invention relates generally to the field of aeroponics.

### BACKGROUND

As the world searches for more efficient and environmentally friendly methods to provide food for the masses, increasing attention has been given to alternative agricultural methods, such as hydroponics and aeroponics. Hydroponics is a method of growing plants by cultivating them in a nutrient-rich, water-based solution instead of in soil. Aeroponics is a method of growing plants by suspending them in the air and exposing the roots to a nutrient-rich mist or fog, eliminating the growing medium altogether. Aeroponics, in particular, has several advantages over traditional agricultural methods, including the abilities to function in limited space, conserve water, and minimize exposure to pests.

In spite of the advantages of aeroponics, current aeroponic systems do have some limitations. Although aeroponics requires significantly less water than traditional agricultural systems, much of the water that is sprayed on the plants is not absorbed and is still, therefore, lost. Using every drop of water to the greatest advantage is important given the additional difficulty and cost of incorporating nutrients into the water.

Current improvements of aeroponics systems have focused on methods for better distribution of the fog or mist in order to minimize energy expenditure and improve water absorption. Vertical systems allow gravity to assist in the water distribution. Carefully engineered misters allow for finer droplets of water. However, maximum water efficiency is still not realized.

### SUMMARY

In a first aspect, the disclosure provides an apparatus comprising an aeroponic growing container and a fog transportation system that moves nutrient-rich fog into the aeroponic growing container. The aeroponic growing container comprises one or more electrically grounded plants, and the fog transportation system comprises an electrode that transfers an electrical charge to the nutrient-rich fog. The nutrient-rich fog is thereby attracted to the one or more plants. In some embodiments, the plants are grounded by means of one or more wires that connect the plants to the ground or one or more electrical outlets.

In a second aspect, the disclosure provides an apparatus comprising an aeroponic growing container and a fog transportation system that moves nutrient-rich fog into the aeroponic growing container. The aeroponic growing container comprises one or more electrically grounded plant support structures that suspend one or more plants, and the fog transportation system comprises an electrode that transfers an electrical charge to the nutrient-rich fog. The nutrient-rich fog is thereby attracted to the one or more plants. In some embodiments, the plant support structures comprise apertures in the aeroponic growing container. In some embodiments, the plant support structures comprise baskets, which may comprise mesh disks. In some embodiments, the plant support structures are grounded by means of one or more wires that connect the plant support structures to the ground or one or more electrical outlets. In some embodiments, the plant support structures are arranged vertically. In some embodiments, the plant support structures are arranged vertically.

In a third aspect, the disclosure provides a method wherein an aeroponic growing container is provided. The aeroponic growing container comprises one or more plant support structures that suspend one or more plants. The one or more plant support structures are electrically grounded. Nutrient-rich fog is transported into the aeroponic growing container by means of a fog transportation system. The fog transportation system comprises an electrode that transfers an electrical charge to the nutrient-rich fog, such that the nutrient-rich fog is electrically attracted to the one or more plants.

Further aspects and embodiments are provided in the foregoing drawings, detailed description, and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is an isometric view of a preferred embodiment of the invention comprising electrically grounded plant support structures, wherein the plant support structures are baskets;

FIG. 2 is a top view of a preferred embodiment of the aeroponic growing container;

FIG. 3 is a cross-sectional view of a preferred embodiment of the aeroponic growing container;

FIG. 4 is an isometric view of one embodiment of the invention comprising electrically grounded plant support structures, the plant support structures being apertures;

FIG. 5 is an isometric view of one embodiment of the invention comprising electrically grounded plants;

FIG. 6 is an isometric view of one embodiment of the invention comprising an acoustic vibration apparatus and artificial lights; and

FIG. 7 is a cross-sectional view of one embodiment of the aeroponic growing container, wherein the electrically grounded plant support structures are vertically arranged.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, aeroponic growing container is meant to refer to a container that houses an aeroponics system. An aeroponics system is a system for growing plants by suspending the plant roots in the air and spraying them with nutrient-rich solutions. Generally, there is no growing medium—like soil, gravel, sand, perlite, or liquid substrate—used in an aeroponics system.

As used herein, electrically grounded is meant to refer to being connected to a large conducting body (such as the earth) that is used as a common return for an electric circuit and as an arbitrary zero of potential.

As used herein, the ground is meant to refer to the surface of the Earth.

As used herein, fog is meant to refer to a mist of fine liquid particles.

As used herein, sump is meant to refer to a low space that collects liquids such as water.

As used herein, electrode is meant to refer to a conductor through which a current enters or leaves a nonmetallic medium.

As used herein, mesh is meant to refer to material of interwoven or intertwined texture with evenly spaced holes.

As used herein, electrical charge is meant to refer to an imbalance of electricity in a body (either positive or negative) due to an excess or deficiency of electrons.

As used herein, electrically attracted is meant to refer to two unlike charges being drawn together by an electrostatic force.

As used herein, suspend is meant to refer to hanging so as to be free on all sides except at the point of support.

As used herein, basket is meant to refer to something that resembles a basket especially in shape or use.

As used herein, aperture is meant to refer to a hole and the walls that form it.

As used herein, electrical outlet is meant to refer to a socket by which electrical devices are connected to an electrical supply, especially a three-pong socket that includes a ground terminal.

The invention comprises an aeroponic growing container comprising one or more electrically grounded plants. According to the invention, the plants are electrically grounded, and there are at least two means for electrically grounding the plants. The preferred means is by contact between the plants and one or more electrically grounded plant support structures that suspend the one or more plants. Another means is by electrically grounding the plants directly. The invention also comprises a fog transportation system that moves nutrient-rich fog into the aeroponic growing container. The fog transportation system comprises an electrode that transfers an electrical charge to the nutrient-rich fog, such that the nutrient-rich fog is electrically attracted to the one or more electrically grounded plants. Because of this electrical attraction between the nutrient-rich fog and the plants, more of the water that is sprayed on the plants is able to be absorbed, thus maximizing water efficiency and conservation.

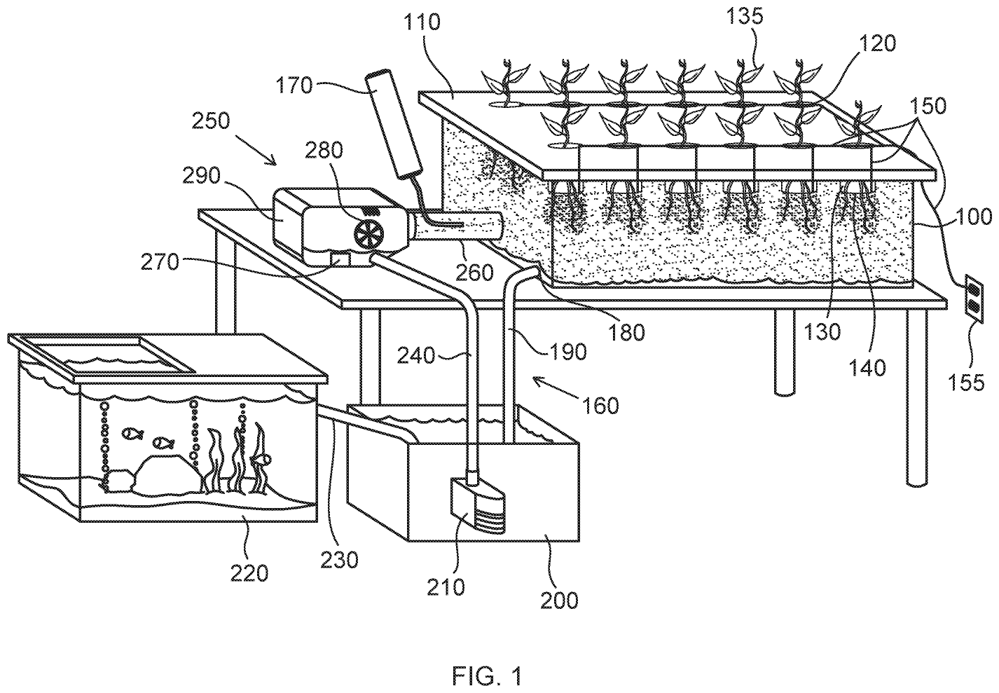

Now referring to FIG. 1, a preferred embodiment of the invention is depicted. In the preferred embodiment, the aeroponic growing container 100 is a plastic, thirty-gallon bin with a substantially rectangular prismatic configuration, with four side walls, a bottom wall, and a top wall 110. In the preferred embodiment, the top wall 110 is a lid that may be removable. In the preferred embodiment, the aeroponic growing container 100 is approximately 14 inches deep.

In other embodiments, the aeroponic growing container may be a box, carton, case, or another container with a substantially rectangular prismatic configuration, or it may be a tube, pipe, channel, or another elongated cavity with a substantially cylindrical configuration. In yet another embodiment, the aeroponic growing container may be a bucket, such as a five-gallon bucket. In still another embodiment, the aeroponic growing container may be an entire room or greenhouse chamber. It may have a humidity dome on top. The aeroponic growing container may have other varied geometrical configurations and sizes (which may depend on the desired number and size of plants).

Preferably, the aeroponic growing container is an enclosed container. An enclosed container can allow nutrient-rich fog to be retained and concentrated in a saturated environment for the plant roots, and it can help shield against pests. The aeroponic growing container may be airtight. The aeroponic growing container may or may not have a lid. The aeroponic growing container, or the lid, may also comprise different materials in alternative embodiments, such as metal, polyvinyl chloride (PVC), glass, wood, or foam. Preferably, the aeroponic growing container comprises a water-resistant material.

The size of the aeroponic growing container may also vary by embodiment. Preferably, the aeroponic growing container is between 1 and 100 gallons. More preferably, it is between 5 and 50 gallons. Even more preferably, it is between 10 and 40 gallons. Preferably, the aeroponic growing container is at least 12 inches deep to allow for adequate fog propagation.

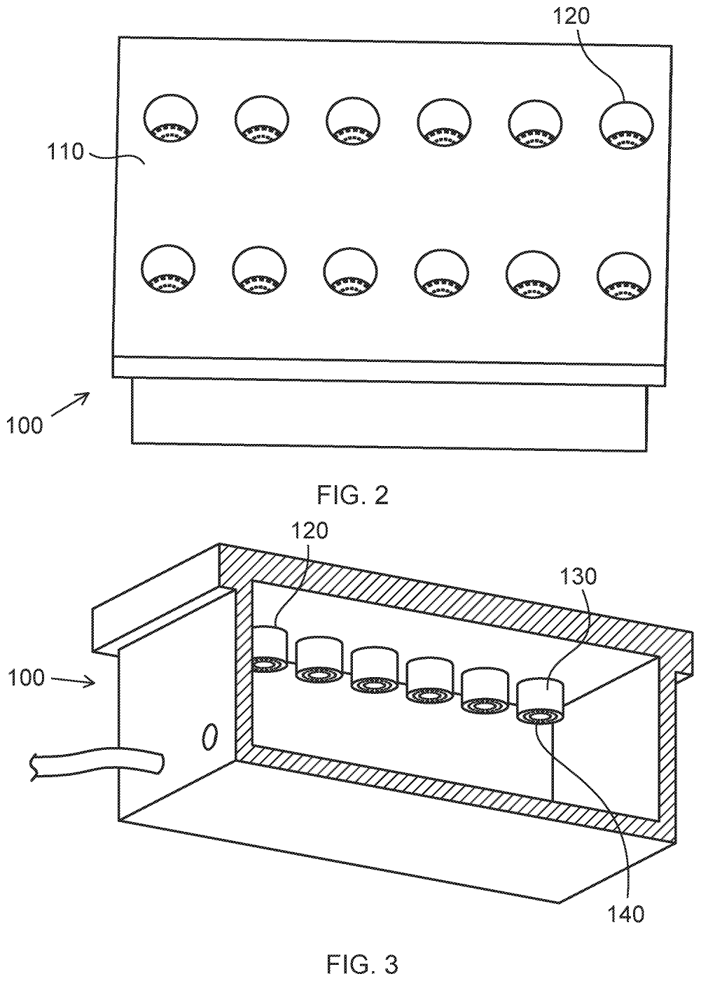

Now referring to FIG. 2, in the preferred embodiment of the invention, the aeroponic growing container 100 comprises one or more apertures 120 along the periphery of the aeroponic growing container 100. In the preferred embodiment, the one or more apertures 120 are cut into the lid 110. In the preferred embodiment, each aperture 120 is substantially round and approximately three-fourths inch in diameter. Furthermore, the preferred embodiment comprises 12 evenly spaced apertures 120 arranged horizontally in rows along the lid 110.

In alternative embodiments, the aeroponic growing container may or may not comprise apertures. Embodiments in which the aeroponic growing container is a room or greenhouse, for example, may not comprise apertures. In embodiments that do include apertures, the size and number of apertures may depend on the desired type and number of plants—one for each plant—but there would preferably be between 1 and 500 apertures, more preferably between 5 and 100 apertures, even more preferably between 10 and 50 apertures. In some embodiments, the apertures may be between 0.25 and 10 inches in diameter, more preferably measuring between 0.5 and 6 inches in diameter. Preferably, the apertures are substantially round, although other geometric configurations are possible. The apertures may be evenly or unevenly spaced, and they may or may not be aligned in rows. The apertures may be horizontally or vertically arranged around the periphery of the aeroponic growing container, such as on the top or around the sides. In some embodiments, the one or more apertures may be cut intermittently along the entire periphery of the aeroponic growing container, such as around the circumference of a cylindrical aeroponic growing container, in columns or spirals.

Now referring to FIG. 3, the preferred embodiment of the aeroponic growing container 100 comprises one or more electrically grounded plant support structures 130 that suspend one or more plants. In the preferred embodiment, the one or more electrically grounded support structures 130 are plastic baskets that are inserted into the one or more apertures 120. The mouths of the plastic baskets are also substantially round and approximately three-fourths inches in diameter. The plastic baskets extend a few inches down into the aeroponic growing container 100.

In the preferred embodiment, the baskets comprise mesh disks 140. Preferably, the bottoms of the plastic baskets are open and the mesh disks 140 are placed inside the baskets to form the bottom of the baskets. Preferably, the mesh disks 140 are made of metal. In the preferred embodiment, the mesh disks 140 are also round and flat and approximately three-fourths inch in diameter. The mesh disks 140 comprise numerous openings. The openings in the mesh disks 140 allow the plant roots to grow through them, such that the plant root systems can dangle below the mesh disks 140 within the aeroponic growing container 100, while the plant shoot systems grow above the mesh disks 140, inside the baskets, and then up and out of the top of the aeroponic growing container 100.

In the preferred embodiment, one or more seeds are sprouted in small pieces of rock wool in a discrete location, and then the pieces of rock wool containing the seeds, which may have grown into small plants, are then inserted within the one or more electrically grounded plant support structures 130, such that the budding plants are suspended in the air above the interior of the aeroponic growing container 100 by the mesh disks 140. As the plants continue to grow, the roots of the plants extend through the mesh disks 140, while the plant shoots grow upward to eventually extend out of the aeroponic growing container 100. As the plants grow to fill and cover the mesh disks 140, the aeroponic growing container 100 is more fully enclosed, as the apertures 120 are plugged by the baskets and plants 135. The enclosed condition is valuable for allowing nutrient-rich fog to be retained and concentrated within the aeroponic growing container 100, creating a saturated environment for the plant roots.

Referring again to FIG. 1, the one or more plant support structures 130 are electrically grounded. In the preferred embodiment, the plant support structures 130 are grounded by means of one or more wires 150 that connect the plant support structures 130 to the ground or to one or more electrical outlets 155 (to the ground terminal). Preferably, the wires 150 are attached to the metal disks 140 of the one or more plant support structures 130. The wires 150 may be attached by being wrapped around the metal disks 140, by welding or soldering, or by means of an adhesive, a clip, a hook, or a fastener. Preferably, one wire 150 is attached to each metal disk 140, and then the wires 150 are joined in a common thread that runs to the ground or to the ground terminal of one or more electrical outlets 155. By this means, the one or more plant support structures 130 are electrically grounded. When the plants 135 come in contact or near contact with the plant support structures 130, the plants 135 also become electrically grounded.

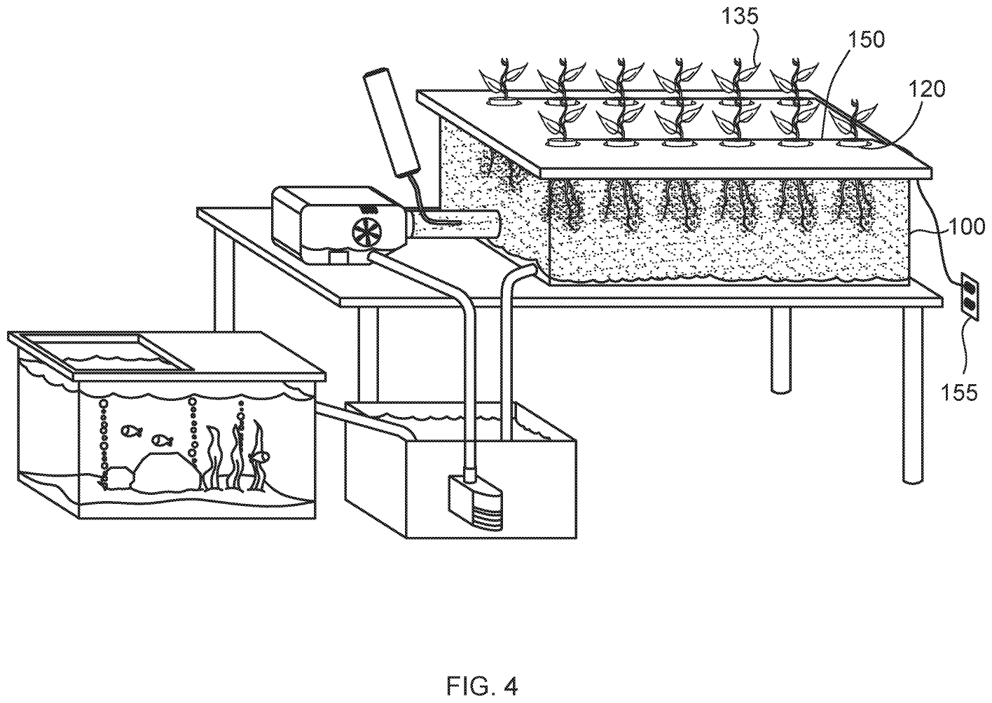

In an alternative embodiment, depicted in FIG. 4, the plant support structures are the one or more apertures 120. In this embodiment, there are no baskets or metal disks. Pieces of rock wool containing seeds, which may have grown into small plants 135, are inserted snuggly into the one or more apertures 120, such that the plants 135 are suspended in the air above the interior of the aeroponic growing container 100 by means of the apertures 120. The pieces of rock wool should be substantially the same size as the apertures 120, just slightly smaller so that they can be snuggly fitted inside. In this embodiment, the edges or walls of the one or more apertures 120 are electrically grounded. In one embodiment, the apertures 120 are lined with metal. For example, a metal ring may be placed around the edges of the apertures 120. The edges or walls of the apertures 120 may be grounded by means of one or more wires 150 that connect the edges or walls of the apertures 120 to the ground or to one or more electrical outlets 155 (to the ground terminal). For example, the wires 150 may be attached to the metal rings that line the edges of the apertures 120. The wires 150 may be attached by being wrapped around the metal rings, by welding or soldering, or by means of an adhesive, a clip, a hook, or a fastener. Preferably, one wire 150 is attached to each metal ring, and then the wires 150 are joined in a common thread that runs to the ground or to the ground terminal of one or more electrical outlets 155. By this means, the edges or walls of the apertures 120 are electrically grounded. When the plants 135 are inserted into the apertures 120, such that the plants 135 or the rockwool that houses the plants 135 (which is conductive when it is wet) come into contact with the electrically grounded edges or walls of the apertures 120, the plants 135 also become electrically grounded.

In other embodiments, the one or more electrically grounded plant support structures may be baskets made entirely or almost entirely of metal. Or they may be baskets made of other materials, such as twine, straw, hair, thread, grass, leaves, willows, reeds, bamboo, etc. The baskets may comprise metal disks, or metal rings, or metal protrusions. The baskets may be of various shapes and sizes. Alternatively, the plant support structures may be net pots, cups, or nets of various shapes and sizes. Alternatively, the plant support structures may be trays, towers, pots, lids, clips, or other structures of different shapes and sizes that suspend one or more plants in the aeroponic growing container. One or more seeds may be sprouted directly within the plant support structures or within various discrete materials, such as rock wool, soil, vermiculite, peat, compost, fertilizer, etc., and then transferred to the plant support structures.

The one or more plant support structures may be electrically grounded by various means. They may be grounded by means of one or more wires that connect the plant support structures—particularly metal parts of the plant support structures—to the ground or to one or more electrical outlets (to the ground terminal). The one or more plant support structures might also be grounded by means of one or more wires that connect the plant support structures to a metal water pipe under a kitchen or bathroom sink, or by means of a wire that connects the plant support structures to a metal, preferably copper, ground rod in the ground outside. The one or more plant support structures might also be grounded by means of a ground clamp attached to a power supply.

The wires may be attached to metal disks, metal rings, metal protrusions, or other metal parts of the one or more plant support structures. The wires may be attached by wrapping, welding, or soldering, or by means of an adhesive, a clip, a hook, or a fastener. Separate wires may be attached to each plant support structure, and then the wires may be joined in a common thread that runs to the ground or to the ground terminal of one or more electrical outlets. Alternatively, separate wires may be attached to each plant support structure and then attached separately to the ground or to the ground terminal of one or more electrical outlets, or one continuous wire may connect each of the plant support structures. Because the plant support structures are electrically grounded, when the plants come in contact with the plant support structures, the plants also become electrically grounded.

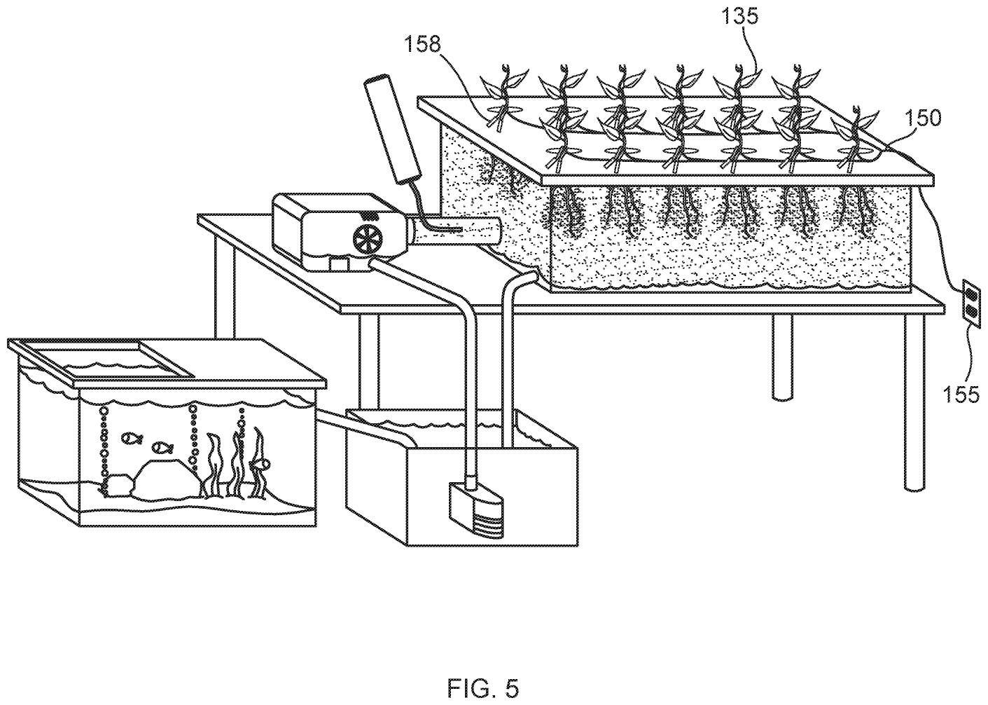

In still another embodiment, as depicted in FIG. 5, the plants 135 are electrically grounded directly, rather than by means of electrically grounded plant support structures. In this embodiment, the plants 135 may be supported or suspended by one or more plant support structures, which may be baskets, apertures, or other support structures. However, rather than grounding the support structures, the plants 135 themselves are grounded. The plants 135 may be electrically grounded by means of one or more wires 150 that connect the plants 135 to the ground or to one or more electrical outlets 155 (to the ground terminal). The one or more wires 150 may be attached directly to the one or more plants 135 with one or more metal clips 158, such as alligator clips, office clips, hair clips, or paper clips, or by wrapping the wire 150 around the plants 135, such as at the roots. The wires 150 may be attached to any part of the plants 135, including the shoots or the roots. One wire 150 may be attached to each plant 135 and then the wires 150 joined in a common thread that runs to the ground or to the ground terminal of one or more electrical outlets 155, or one continuous wire 150 may connect each of the plants 135. By this means, the one or more plants 135 may be electrically grounded directly.

Returning now to FIG. 1, the invention also comprises a fog transportation system 160 that moves nutrient-rich fog into the aeroponic growing container 100. The fog transportation system 160 comprises an electrode 170 that transfers an electrical charge to the nutrient-rich fog, such that the nutrient-rich fog is electrically attracted to the one or more plants 135. In the preferred embodiment, the fog transportation system 160 also comprises a drain 180, a return tube 190, a sump 200 comprising a pump 210, a reservoir 220, a filling tube 230, a drip line 240, a fog machine 250, and a feeding tube 260.

In the preferred embodiment, the aeroponic growing container 100 comprises a drain 180. The drain 180 is a small opening along the bottom edge of one side wall of the aeroponic growing container 100. As fog within the aeroponic growing container 100 condenses, droplets form that pool at the bottom of the aeroponic growing container 100. The pool of water that forms then flows out of the drain 180 so that the water can be recycled and recirculated to be used again in the system. In alternative embodiments, the drain may be located at different positions along the aeroponic growing container, or the aeroponic growing container may have alternative means for the water to be released, such as a door or hatch.

In the preferred embodiment, water that flows out of the drain 180 flows into a return tube 190. In the preferred embodiment, the return tube 190 is a half-inch diameter PVC pipe that is attached to the drain 180. Preferably, the return tube 190 runs at a downward angle from the drain 180 to the sump 200 and is long enough to reach from the drain 180 of the aeroponic growing container 100 to the sump 200. Preferably, the return tube 190 is attached to the drain 180 by means of a watertight, threaded connection, such as a bulkhead fitting.

In alternative embodiments, a return tube may or may not be present. The return tube may be bigger or smaller, and it may be made of alternative materials, such as flexible plastic, paper, metal, or other materials commonly known in the art. In an alternative embodiment, the return tube may run from the aeroponic growing container to the reservoir rather than the sump.

In the preferred embodiment, the fog transportation system 160 comprises a sump 200. The sump 200 is the lowest point in the system. In the preferred embodiment, the sump 200 is a tub partially filled with nutrient-rich water. In alternative embodiments, the sump may be a bucket, bin, basin, pan, pool, bowl, trough, or another container capable of holding a liquid solution and a pump.

The sump 200 houses a pump 210 in the preferred embodiment. Preferably, the pump 210 is a submersible pond pump with a power cord, which operates at between 100 and 1000 gallons per hour, more preferably between 200 and 700 gallons per hour. In alternative embodiments, the pump may be another type of pump, such as a utility or sump pump, and it may be made from various materials and powered by various means, such as by batteries. The pump 210 pumps nutrient-rich water from the sump 200 through the drip line 240 to the fog machine 250. In the preferred embodiment, the drip line 240 is a quarter-inch diameter flexible plastic tube that is attached to both the pump 210 and the fog machine 250. Preferably, the drip line 240 is attached to the top of the pump 210. In alternative embodiments, the drip line may or may not be present. The drip line may be larger or smaller or made from different materials. In alternative embodiments, the sump may use gravity rather than a pump to move water to the fog machine.

In the preferred embodiment, nutrient-rich water is fed to the sump 200 by means of a filling tube 230 from a reservoir 220. In the preferred embodiment, the filling tube 230 is a half-inch diameter PVC pipe that runs from the reservoir 220 downward to the sump 200. In alternative embodiments, the filling tube may or may not be present. It may also be larger or smaller or made from different materials.

In the preferred embodiment, the reservoir 220 is a glass fish tank, and the fish provide the nutrients that enrich the water for feeding the plants 135 in the aeroponic growing container 100. In alternative embodiments, the reservoir may be a bucket, bin, barrel, drum, cask, basin, tub, vat, cistern, jug, keg, pan, pool, bowl, trough, or another container capable of holding a liquid solution. The reservoir may have various shapes and sizes, which may depend upon the desired amount of water to be held in the reservoir. The reservoir may comprise any of a variety of different materials, such as plastic, wood, metal, concrete, rubber, stone, porcelain, fiberglass, glass, polyester fibers, and other materials known to those of ordinary skill in the art. In some embodiments, the reservoir might not contain fish. The reservoir may instead contain a system for preparing and monitoring the nutrient-rich water, as known by those of ordinary skill in the art.

In an alternative embodiment, there is no reservoir or filling tube, but the sump acts alone to hold the nutrient-rich water. In this embodiment, because the nutrient-rich water is not fed to the sump from the reservoir, nutrient-rich water may be prepared directly within the sump. The nutrient-rich water is prepared by adding nutrients to water, according to methods known to those of ordinary skill in the art. For example, the nutrient-rich water may comprise nitrates and ammonia, with 300 parts per million in nitrates and 600 parts per million of ammonia. In another embodiment, there is no sump, but only a reservoir from which water is moved to the fog machine by a pump or by gravity.

In the preferred embodiment, nutrient-rich water is pumped by the pump 210 from within the sump 200 and transferred by way of the drip line 240 to the fog machine 250. In the preferred embodiment, the fog machine 250 is retrofit from pre-existing separate parts. In the preferred embodiment, the fog machine 250 comprises an ultrasonic mister 270 housed within an outer casing 290. The outer casing 290 may be a plastic bin. When the pump 210 moves nutrient-rich water from the sump 200 through the drip line 240 and into the outer casing 290 of the fog machine 250, the ultrasonic mister 270 becomes submerged by the nutrient-rich water within the fog machine 250. Preferably, the ultrasonic mister 270 should be submerged not more than approximately 40 milliliters below the surface of the water. To maintain the appropriate water level, a float valve may be used to open access to the drip line 240 when the water level is low and to close access to the drip line 240 when the water level is high. The ultrasonic mister 270 converts the nutrient-rich water supplied by the drip line 240 into nutrient-rich fog.

The fog machine 250 also comprises a fan 280 that pulls air into the fog machine 250, creates pressure inside, and then pushes the nutrient-rich fog created by the ultrasonic mister 270 out of the fog machine 250 and into the feeding tube 260. In the preferred embodiment, the fan 280 is a computer fan. A hole is cut in the outer casing 290 of the fog machine 250 for the fan 280. Other holes are cut in the outer casing 290 to connect the drip line 240 and feeding tube 260, which may be attached by means of bulkhead fittings or other connectors. Preferably, the fog machine 250 is watertight and airtight apart from these holes.

In alternative embodiments, the fog machine may be any of a variety of aeroponic misters that are commercially available, preferably with droplet sizes of less than 80 microns, and more preferably with droplet sizes of less than 50 microns. In other embodiments, the fog transportation system might not comprise a fog machine, but fog is moved into the aeroponic growing container by alternative means, such as by a spray nozzle system. In one alternative embodiment, the fog transportation system may be a high-pressure system. In this system, there may be no sump, pump, or fog machine. There may be only a pressurized reservoir—a reservoir that is divided in two, with one side holding nutrient-rich water and the other side holding compressed air. A water line may run from the reservoir to misters within the aeroponic growing container. A solenoid valve may be used to control the water flow through the water line to the misters based on the timing of a cycle timer.

In the preferred embodiment, a feeding tube 260 is attached from the fog machine 250 to the aeroponic growing container 100. In the preferred embodiment, the feeding tube 260 is a two-inch diameter PVC pipe, and it is connected to the fog machine 250 by PVC fittings, and it is connected to the aeroponic growing container 100 by bulkhead connectors. Preferably, the connections are airtight and watertight. In alternative embodiments, other connectors may be used. In alternative embodiments, the feeding tube may be larger or smaller or made from other materials, such as flexible plastic or glass. Preferably, the feeding tube is at least 2 inches in diameter so that the fog can move freely through the tube without overly condensing.

The nutrient-rich fog generated by the fog machine 250 is blown from the fog machine 250, through the feeding tube 260, into the aeroponic growing container 100. In the preferred embodiment, an electrode 170 is inserted into the feeding tube 260 such that the nutrient-rich fog will flow past and around the electrode 170 when blown by the fog machine 250. The electrode 170 transfers an electrical charge—preferably a negative electrical charge—to the nutrient-rich fog as it passes. Because the nutrient-rich fog is electrically charged after passing the electrode 170, the nutrient-rich fog is, when it enters the aeroponic growing container 100, electrically attracted to the one or more plants 135 that have been electrically grounded, whether directly or by means of electrically grounded plant support structures 130, within the aeroponic growing container 100. Because of this electrical attraction, the nutrient-rich fog will be absorbed more abundantly and efficiently by the plants.

In the preferred embodiment, the electrode 170 is an electrode taken from a commercially available powder coating gun, such as a Central Machinery® powder coating system. The plastic coating is removed to expose a quarter-inch diameter stainless steel rod connected by means of a wire to a high-voltage power supply. In alternative embodiments, the rod may be made from any conductive alloy, such as copper, silver, aluminum, nickel, brass, iron, lead, etc. A tiny hole is punctured in the feeding tube 260, and the tip of the stainless steel rod is pushed inside the feeding tube 260 through the hole, into which it barely fits, creating an airtight seal. The high-voltage power supply is activated to deliver a charge to the rod, which then transfers the charge to the nutrient-rich fog that is being blown past the rod. In alternative embodiments, the electrode transfers a positive charge to the nutrient-rich fog. In different embodiments, the electrode may be any other apparatus that can transfer a charge to the nutrient-rich fog.

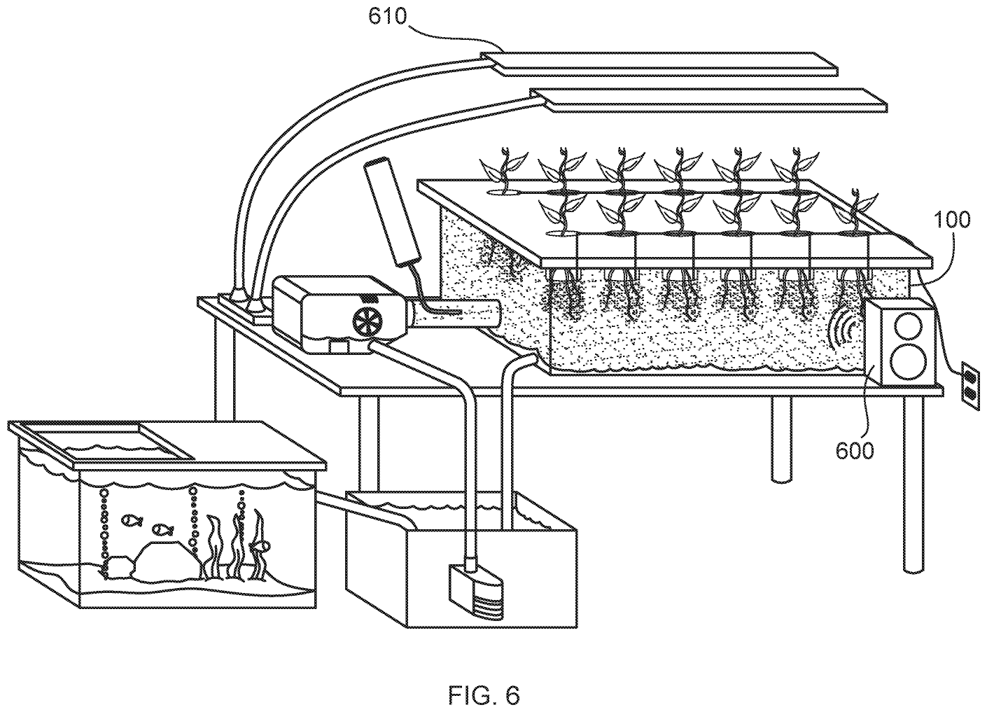

FIG. 6 depicts one embodiment of the invention comprising additional features for helping to grow stronger and healthier plants. Specifically, FIG. 6 depicts the invention comprising an acoustic vibration apparatus 600 and artificial lights 610. Various embodiments of the invention may include both an acoustic vibration apparatus 600 and artificial lights 610, just one or the other, or neither.

The acoustic vibration apparatus 600 creates acoustic vibrations. The acoustic vibrations may disrupt or shake the plants, mimicking the disruptions that the plants would be exposed to if grown in a natural outdoor medium, such as soil. Disrupting the roots or stalks or the roots and stalks of the plants can help the plants to grow heartier and stronger.

In one embodiment, the acoustic vibration apparatus 600 is a speaker. The speaker may be waterproof. The speaker may emit a low-frequency sound, such as white noise or music or a nature sound. The speaker may be placed within the aeroponic growing container 100, and it may be secured to a side wall of the container, preferably along a lower edge of the side wall. The speaker may be electrically powered, with a power cord extending from the speaker, through a hole cut in a wall of the aeroponic growing container, and to an electrical outlet. The hole may be sealed with an airtight and waterproof seal. Alternatively, the speaker may be battery powered.

The speaker may be placed outside of the aeroponic growing container 100. In this case, the speaker may be attached to a ceiling above the aeroponic growing container 100 or to a wall near the aeroponic growing container 100. The speaker may be set on a chair or counter near the aeroponic growing container 100. It may also be attached to the outside of a side wall of the aeroponic growing container 100.

The artificial lights 610 allow the invention to be used indoors while exposing the plants to lighting that imitates the sunlight outside. The lighting helps the plants to grow stronger and healthier. Preferably, the artificial lights 610 would be LED lights, but they may also be fluorescent lights, incandescent lights, halogen lights, HID lights, or horticultural grow lights. The artificial lights 610 may be full spectrum lights or lights that focus on red, green, or blue wavelengths, or lights that are able to change spectrum at different times according to the needs or growth cycle of the plants. The artificial lights 610 may be automated to turn on and off according to programmable schedules. The schedules may be programmed by means of a microcontroller in the lights controlled by a computer, smart phone, or remote control. The artificial lights 610 may be turned on for 14 hours and off for 10 hours each day, or they may be turned on for 12 hours and turned off for 12 hours each day. Preferably, the lights would be turned on for at least 5 hours each day.

The artificial lights 610 would preferably be placed above the aeroponic growing container 100. The distance between the artificial lights 610 and the aeroponic growing container 610 may depend on the amount of heat emitted from the artificial lights 610. The artificial lights 610 may be strung or hung, supported on a stand or clamped.

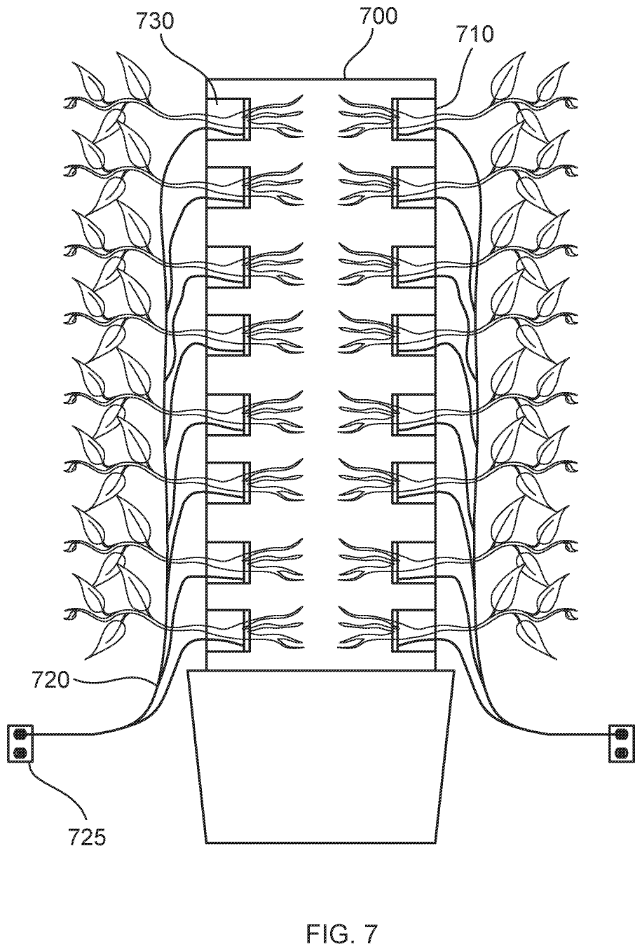

FIG. 7 depicts one alternative embodiment of the aeroponic growing container 700. In this embodiment, the aeroponic growing container 700 is a tube comprising an elongated cavity with a substantially cylindrical configuration. One or more apertures 710 are cut intermittently along the entire periphery of the aeroponic growing container 700, vertically arranged around the circumference of the cylindrical aeroponic growing container. The apertures 710 may be aligned in columns. The aeroponic growing container 700 also comprises one or more electronically grounded plant support structures 730. The plant support structures 730 may be plastic baskets with mesh disks inside. The disks may be made of metal. The plant support structures 730 may be displaced inside the apertures 710. Alternatively, the plant support structures 730 may be the apertures themselves, or another type of support structure that suspends the one or more plants. The plant support structures 730 may be vertically arranged along the aeroponic growing container 700.

The plant support structures 730 may be grounded by means of one or more wires 720 that connect the plant support structures 730—particularly metal parts of the plant support structures—to the ground or to the ground terminal of one or more electrical outlets 725. Alternatively, the plants may be electrically grounded themselves by means of one or more wires that connect the plants to the ground or to the ground terminal of one or more electrical outlets. Furthermore, in this embodiment, the fog transportation system may be located above the aeroponic growing container, allowing gravity to assist in the fog distribution.

The invention has been described with reference to various specific and preferred embodiments and techniques. Nevertheless, it is understood that many variations and modifications may be made while remaining within the spirit and scope of the invention.

What is claimed is:

1. An apparatus comprising:
an aeroponic growing container comprising one or more electrically grounded plants; and
a fog transportation system that moves nutrient-rich fog into the aeroponic growing container, the fog transportation system comprising an electrode that transfers an electrical charge to the nutrient-rich fog, such that the nutrient-rich fog is electrically attracted to the one or more plants.

2. The invention of claim 1, wherein the plants are grounded by means of one or more wires that connect the plants to the ground or to one or more electrical outlets.

3. The invention of claim 1, wherein the aeroponic growing container comprises a plastic bin.

4. An apparatus comprising:
an aeroponic growing container comprising one or more electrically grounded plant support structures that suspend one or more plants; and
a fog transportation system that moves nutrient-rich fog into the aeroponic growing container, the fog transportation system comprising an electrode that transfers an electrical charge to the nutrient-rich fog, such that the nutrient-rich fog is electrically attracted to the one or more plants.

5. The invention of claim 4, wherein the plant support structures comprise apertures in the aeroponic growing container.

6. The invention of claim 4, wherein the plant support structures comprise baskets.

7. The invention of claim 6, wherein the baskets comprise mesh disks.

8. The invention of claim 4, wherein the plant support structures comprise metal.

9. The invention of claim 4, wherein the plant support structures are grounded by means of one or more wires that connect the plant support structures to the ground or to one or more electrical outlets.

10. The invention of claim 4, wherein the plant support structures are arranged horizontally.

11. The invention of claim 4, wherein the plant support structures are arranged vertically.

12. The invention of claim 4, wherein the aeroponic growing container comprises a plastic bin.

13. The invention of claim 4, further comprising an acoustic vibration apparatus.

14. The invention of claim 4, further comprising artificial lights.

15. A method comprising:
providing an aeroponic growing container comprising one or more plant support structures that suspend one or more plants;
electrically grounding the one or more plant support structures; and
transporting nutrient-rich fog into the aeroponic growing container by means of a fog transportation system, the fog transportation system comprising an electrode that transfers an electrical charge to the nutrient-rich fog, such that the nutrient-rich fog is electrically attracted to the one or more plants.

16. The invention of claim 15, wherein the plant support structures comprise baskets.

17. The invention of claim 16, wherein the baskets comprise mesh disks.

18. The invention of claim 15, wherein the plant support structures comprise metal.

19. The invention of claim 15, wherein the plant support structures are grounded by means of one or more wires that connect the plant support structures to the ground or to one or more electrical outlets.

20. The invention of claim 15, wherein the plant support structures are arranged horizontally.
